(19) United States
(12) Patent Application Publication
(10) Pub. No.: US 2004/0055001 A1
(43) Pub. Date: Mar. 18, 2004

(54) Method and apparatus for computational load sharing in a multiprocessor architecture

(76) Inventor: Farhad Fuad Islam, Apex, NC (US)

Correspondence Address: Michael G. Savage, BURNS, DOANE, SWECKER & MATHIS, L.L.P., P.O. Box 1404, Alexandria, VA, 22313-1404, US

(21) Appl. No.: 10/160,890

(22) Filed: Sep. 16, 2002

(51) Int. Cl. G06F 9/00

(52) U.S. Cl. 718/106

(57) ABSTRACT

In a multiprocessor system, a general-purpose processor, or main processor (MP), shares the computational load with one or more specific-purpose processors, such as a DSP(s). As soon as the MP is available for computational load sharing, i.e., finishes other tasks, the MP checks the computation status of a DSP and shares some of the computation load with the DSP, preferably only when practicable. The MP operates on the same signal processing data as the DSP. The data is retrieved for computation by the MP from a memory using a bottom-up approach while the DSP retrieves data using a top-down approach. An address comparator compares the address of the MP accessed memory location with that of the DSP. When the addresses are the same, the “meeting point” is detected and the current computation is deemed complete. The overall computation time of relevant digital signal processing is reduced.

### BACKGROUND

The present invention is related to processing data efficiently, and more particularly to computational load sharing in a multiprocessor architecture.

Multiprocessor systems are conventionally employed for a variety of computational tasks. Typically, the various operation processes, or tasks, are distributed among the multiple processors. The various tasks are allocated between the processors so that each task is assigned to a suitable processor for that task. There is typically one general-purpose processor and one or more specific-purpose processors.

One example of multiprocessor system architecture includes a microcontroller unit (MCU), or main processor, and one or more digital signal processors (DSP), which may be denoted as a MCU-DSP system. The main processor serves as the general-purpose processor and the DSP serves as specific-purpose processors.

In general, processing can be divided into two broad categories: those that require mostly numerically intensive computation, and those that are control oriented, i.e., handle input/output of data. The conventional approach to dividing the two different processing duties in MCU-DSP systems is to dedicate the DSP for the numerically intensive computation and the MCU for the input/output of data. This is because DSPs offer greater computational power when the processes are numerically oriented, while main processors are better suited for control-oriented processes. In addition, the respective instruction sets of these processors are typically tuned for the corresponding applications.

Many embedded applications have a component process that is DSP oriented and one that is control-oriented. For example, the workload of a cellular phone has a large DSP component that includes the processing required for the base-band channel, as well as for the speech coders. This workload is numerically intensive, and requires a processor with a large capacity for computation, such as a DSP. At the same time, the cellular phone also involves control-oriented applications since it must manage many aspects of a user interface, as well as communication protocol stacks.

Much of the computational load in such multiprocessor architectures is typically numerically intensive multiplication-accumulation (MAC) computation. The main processor is often idle, awaiting the next control-oriented function, while the numerically intensive computations are carried out in the DSP(s). In order to achieve an overall high computational efficiency, it is therefore desirable to share the numerically intensive computational load among the multiple processors, such as the main processor and one or more DSPs, to attain high speed digital signal processing. It is difficult, however, to efficiently distribute, at run time or on the fly, the computation load among the multiple processors. Accordingly, there is a need to efficiently distribute computational load among the processors in multiprocessor system architecture.

### SUMMARY

The present invention addresses these and other concerns. In a multiprocessor system, a general-purpose processor, e.g., a main processor, shares the computational load with one or more specific-purpose processors, such as a DSP(s). As soon as the main processor is available for computational load sharing, i.e., finishes other tasks, the main processor checks the computation status of the DSP and shares some of the MAC computation load with the DSP, preferably only when practicable. The main processor shares the DSP(s) computational load by accessing values from the same overall data set as the DSP(s) to retrieve values for computation using a bottom-up approach while the DSP(s) are using a top-down approach. By approaching the data set in opposite directions, duplicate operations on the same data value are avoided. Instead, reaching the same data value provides an indication that the shared computation should be totaled. The overall computation time is advantageously reduced because of the load sharing.

According to one aspect, a method of computational load sharing between a general-purpose processor and one or more specific-purpose processor(s) in a multiprocessor system includes retrieving and processing one or more values, by the one or more specific-purpose processor(s), from a set of values in a common memory according to a first memory accessing sequence. The one or more values are then processed to obtain a first cumulative result. One or more other values are retrieved from the set of values in the common memory and processed by the general-purpose processor according to a second memory accessing sequence. The one or more other values are then processed to obtain a second cumulative result. The first and second cumulative results are combined to obtain a final result of a current cumulative computation.

According to another aspect, a system for computational load sharing includes one or more specific-purpose processor(s) adapted to retrieve and process one or more values from a set of values in a common memory according to a first memory accessing sequence. The one or more values are processed to obtain a first cumulative result. The system also includes a general-purpose processor adapted to retrieve and process one or more other values from the set of values in the common memory according to a second memory accessing sequence. The one or more other values are processed to obtain a second cumulative result. Logic in the system combines the first and second cumulative results to obtain a final result of a current cumulative computation.

According to yet another aspect, a general-purpose processor adapted for computational load sharing includes logic that retrieves and processes a subset of values from a common set of values according to an accessing sequence. Meanwhile, a different subset of the common set of values is retrieved by one or more specific-purpose processors according to a different accessing sequence. The subset of values are processed to obtain a cumulative result. The general-purpose processor also includes logic that combines the cumulative result with other cumulative results processed by the one or more specific-purpose processors to obtain a final result of a current cumulative computation.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 is a block diagram illustrating a multiprocessor arrangement according to the invention;

FIG. 2 is a flow chart illustrating a method of load sharing according to an embodiment of the invention;

FIG. 3 is a flow chart illustrating a method of load sharing according to another embodiment of the invention;

FIG. 4 is a flow chart illustrating a method of determining practicability of load sharing according to an embodiment of the invention;

FIG. 5 is a flow chart illustrating a method of initializing a status counter according to an embodiment of the invention;

FIGS. 6A and 6B illustrate an image filtering operation in which load sharing according to the invention may be performed; and

FIG. 7 illustrates a logic diagram for an address comparator circuit for use in the invention.

### DETAILED DESCRIPTION

Preferred embodiments of the present invention are described below with reference to the accompanying drawings. In the following description, well-known functions and/or constructions are not described in detail to avoid obscuring the invention in unnecessary detail.

In a multiprocessor architecture, each processor is typically self-sufficient. In general, the main processor plays the role of master controller and the others, e.g., one or more DSP(s), are computation intensive slaves. The master controller handles interactions with the system, e.g., handles all input/outputs and interrupts, while the slave processors(s) perform the more computation intensive processing, such as multiplication-accumulation (MAC) type computation.

The invention will be described below by way of example for the simplest case, which is a multiprocessor architecture having one main processor and one DSP. The main processor shares, at run-time, preferably whenever practicable, the MAC computation load of the DSP. The invention, however, may be used in any multiprocessor system having a general-purpose processor, such as the main processor, and one or more specific-purpose processors, such as the DSP(s).

The implementation of a typical digital signal processing algorithm in VLSI (Very Large Scale Integration) can be modeled as the combination of two functions, ƒ₁(x,y) and ƒ₂(x,y). For example, ƒ₁(x,y) denotes the pre-processing and post-processing functions on discrete signal samples (x,y) in a two-dimensional (X,Y) coordinate system. These functions primarily involve data input/output but may include some transformation operations on the data, such as scaling. Repetitive operations performed on a series of the discrete signal samples, which include MAC type computations, may be denoted by

$${\sum }^{m} {\sum }^{n} {f}_{2} ( x , y ) ,$$

where m×n is the total number of required MAC computations. The overall VLSI model for a typical digital signal processing algorithm is then represented by the following expression:

$$( \underline{x} , \underline{y} ) = {f}_{1} ( x , y ) + {\sum }^{m} {\sum }^{n} {f}_{2} ( x , y ) \qquad ( 1 )$$

where:

(x,y) is the computed (or filtered) value of a discrete signal sample in a (X,Y) coordinate system,

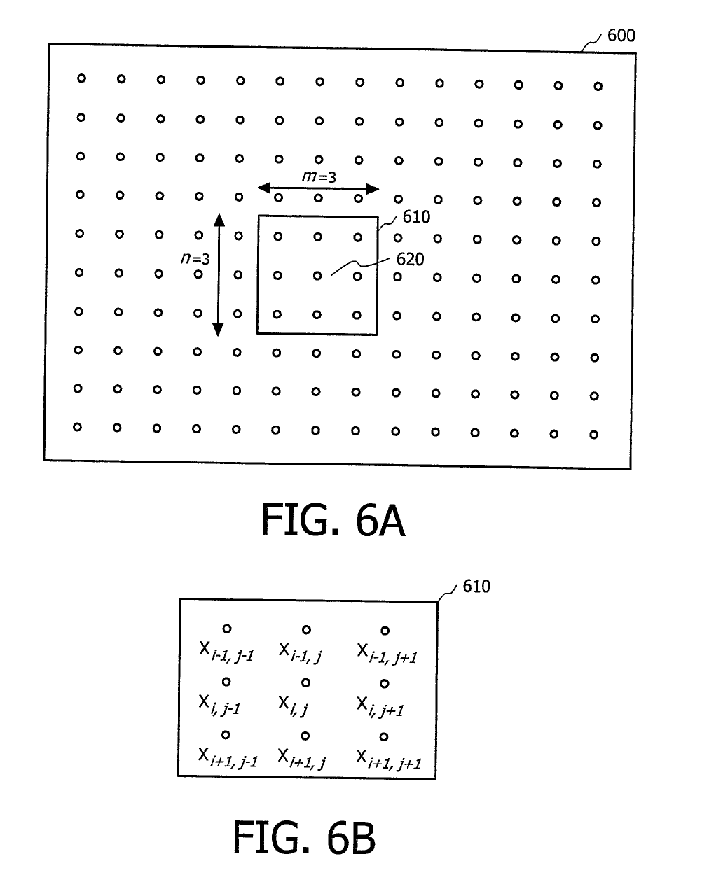

m and n are the width and height, respectively, of a two-dimensional filter mask (as detailed below with reference to FIGS. 6A and 6B), and

ƒ₁(x,y) and ƒ₂(x,y) are functions representing digital signal processing operations on each discrete signal sample in a two-dimensional space.

FIGS. 6A and 6B illustrate a practical application for Eq. 1. In FIG. 6A, a typical image filtering operation is illustrated, whereby an m×n (3×3) filter mask 610 recursively operates on discrete signal samples, e.g., pixels 620, of a picture frame 600, such as a display. In FIG. 6B, the filter mask 610 is illustrated with current preprocessing values appearing next to each pixel being represented by x according to two dimensional screen location i, j, referenced to the center pixel 620. While the mask is operating in each location, the center pixel 620 is undergoing a filtering operation. A new “filtered” value is calculated for the center pixel by multiplying each pixel value by a filter coefficient corresponding to the position of each pixel covered by the mask. The mask coefficient values may be represented by an m×n (3×3) matrix as shown below.

$$[ \begin{matrix}{y}_{11} & {y}_{12} & {y}_{13} \\ {y}_{21} & {y}_{22} & {y}_{23} \\ {y}_{31} & {y}_{32} & {y}_{33}\end{matrix} ] \qquad ( 2 )$$

The MAC computation for the new filtered value x_{i,j} for pixel 620 is calculated according to the following expression.

x_{i,j}=x_{i-1,j-1}*y₁₁+x_{i,j-1}*y₂₁+ . . . x_{i+1,j+1}*y₃₃ (3)

As can be appreciated from Eq. 3, the MAC computation for a pixel 620 includes accumulating (summing) a number of multiplications equal to the number of pixels and/or filter coefficients in the mask. In this simple case, a total of m×n=9 multiplications must be performed and accumulated to filter each pixel.

Referring again to the digital signal processing algorithm Eq. 1, (x,y) represents each pixel 620 that has undergone digital signal processing, such as a filtering operation. The MAC computations of Eq. 3 are represented by

$${\sum }^{m} {\sum }^{n} {f}_{2} ( x , y ) ,$$

for the m×n filter mask. Meanwhile, ƒ₁(x,y) represents data pre-processing and post-processing, and input/output functions that are performed to support the filtering operation. In the digital m signal processing algorithm, the computation load of

$${\sum }^{m} {\sum }^{n} {f}_{2} ( x , y ) ,$$

which is MAC intensive, is typically far greater than the computation load related to ƒ₁(x,y). As discussed above, the DSP in typical dual processor architecture is particularly well suited, and can perform these MAC computations faster than a main processor.

In multiprocessor systems employing computational load sharing, the conventional approach to load sharing between two processors is to assign the MAC computation of ƒ₂(x,y) to the DSP and assign the computation of ƒ₁(x,y) to another processor, perhaps even the main processor, with both calculations being carried out in parallel. Using the conventional approach, however, when the main processor completes the computation of ƒ₁(x,y) before the DSP, the main processor waits idle for the DSP to complete the MAC computation of ƒ₂(x,y).

According to the invention, the main processor acts as a master while the one or more DSPs act as slaves. As soon as the main processor finishes computing ƒ₁(x,y), the main processor checks the computation status of a slave DSP and shares some of the DSP MAC computation load of ƒ₂(x,y). This reduces the overall computation time for the signal processing application.

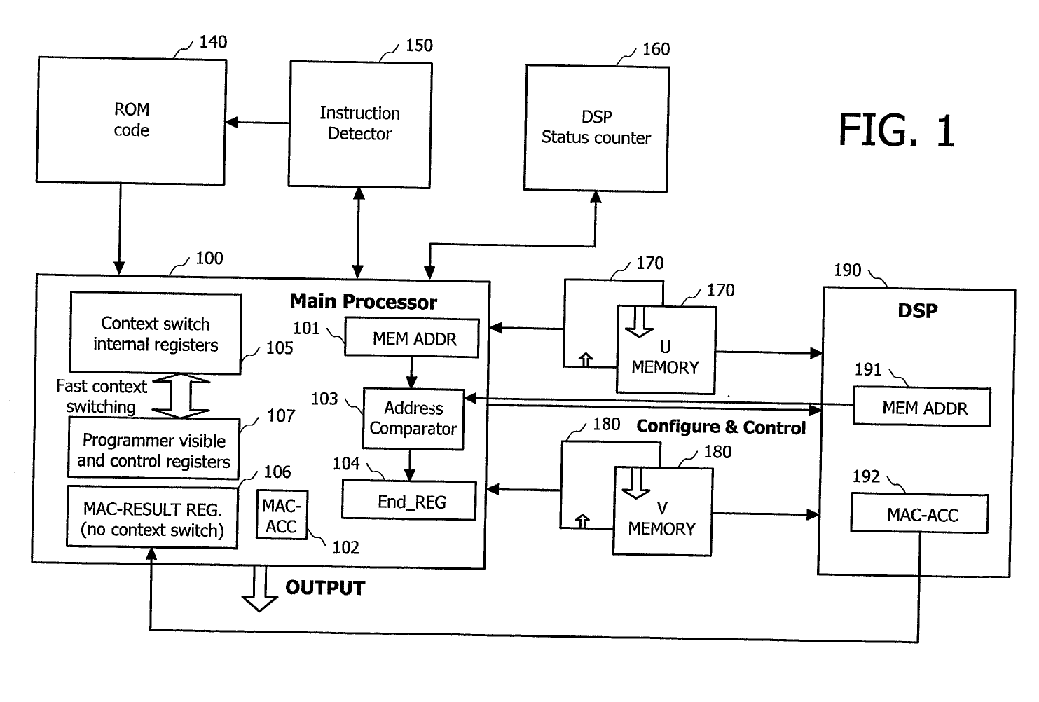

With reference to FIG. 1, a multiprocessor arrangement according to the invention is shown. A main processor (MP) 100, such as a MCU, controls and configures at least one DSP 190. The DSP 190 and MP 100 each have access to a U memory 170 and a V memory 180. The U and V memories 170, 180 may be of a single port type, allowing one processor to read one memory location for each clock pulse, or a dual port type, allowing each of two processors to read a different memory location for each clock pulse. Where a single port memory is used, a duplicate U and V memory must be maintained. The single port memory alternative is illustrated in the example of FIG. 1, with the duplicate memory being represented by a second block for each memory.

The U and V memories 170, 180 contain a plurality of memory locations each storing a numerical value used in the calculation. For example, in the pixel filtering example described above, the U memory 170 stores the x values, which represent each pixel value in the display, and the V memory 180 stores the y values, which are the filter coefficients in the filtering mask that are multiplied by a corresponding x value during a filtering operation.

Once the multiplications are accumulated for a given pixel, the resulting total value is applied to the pixel in the filtering operation according to a filtering procedure. In the following discussion, and in the context of the present example, the process of performing the entire computation for each pixel, as in Eq. 3 above, will be referred to as a “MAC computation”, while each individual multiplication, for example x_{i-1,j-1}*y₁₁, will be referred to as a “calculation.”

The DSP 190 includes a MAC accumulator (MAC-ACC) 192 that accumulates, or sums, the results of the many calculations required. A MAC-ACC 102 is also included in the MP 100 to allow MAC type computation ability in the MP 100, although typically at a slower rate than the DSP 190.

According to the invention, when the MP is idle, e.g., has no control-oriented tasks to perform and has completed its allocated task ƒ₁(x,y), the MAC computational load is shared with the DSP 190. Sharing in the same MAC computation by multiple processors has been considered problematic in prior art systems since the MP 100 would be interfering with or impeding the calculations being performed by the DSP 190. The invention advantageously overcomes this problem by providing means for the MP 100 to perform the calculations using a “bottom-up” approach while the DSP 190 performs the calculations using a “top-down” approach. That is, the MP 100 reads the x and y values from the bottom-up, i.e., last to first, while the DSP 190 simultaneously is reading the x and y values from the top-down, i.e., first to last. When the DSP 190 and MP 100 “meet” somewhere between the first and last data, the accumulated results of each respective set of calculations are added to obtain the final MAC computation result. In practice, the “meeting point” is closer to the bottom, or end, of the list of values because the DSP 190 will typically perform the calculations faster than the MP 100.

The DSP 190 contains a memory address register 191 that is continually updated to contain the current memory address being accessed by the DSP 190 (using the top-down approach) in the U memory 170 of the x value being used in the current calculation. Alternatively, the memory address in the V memory 180 of the y value being used in the current calculation may be used where there is a one to one correspondence in the calculations, as is the case in the example of FIGS. 6A and 6B. A corresponding memory address register 101 in the MP 100 is continually updated to contain the current memory address accessed in the same memory by the MP 100 (using the bottom-up approach).

The two address values are compared by an address comparator 103 and a result of the comparison is written to a register designated End_Reg 104. For example, when the memory addresses in the memory registers 101, 191 are the same, a zero value is written to End_Reg 104. Before beginning each calculation, the MP 100 reads the End_Reg 104 to determine whether the DSP 190 and MP 100 have reached the meeting point yet, i.e., the MP 100 looks for a zero value in End_Reg 104, and if so, the current MAC computation is deemed complete. Otherwise, the MP 100 retrieves the next x and y values and performs the next calculation, repeating the process. Meanwhile, the DSP 190 is continually performing the calculations for the current MAC computation until one of two conditions exist: the last x and y value is reached; or, when the MP has shared in the calculation, the MP 100 notifies the DSP 190 that the calculation is complete, i.e., the MP 100 and DSP 190 have reached the meeting point.

When the MAC computation is shared between the MP 100 and DSP 190, the values in the respective MAC-ACCs 102, 192 are summed by the MP 100 to obtain the result. The summed result is stored in a MAC Result register 106 of the MP 100.

Sharing in the same MAC computation by an MP 100 and DSP 190 has also been considered problematic in prior art systems since a method is needed for incorporating the MAC computational task with the other tasks required of the MP without losing data for either function. The invention advantageously overcomes this problem by securing the current state of the programmer visible and control register set 107 in the MP 100 when switching tasks. This procedure is referred to as “context switching.” Generally speaking, context switching refers to a phase of interrupt mechanisms that enable you to switch from one program, or task, to another without losing the previous state for the first program. When the MP 100 has completed its other tasks, and is therefore available for MAC computational load sharing, an interrupt is received at the MP 100 (generation of the interrupt is discussed further below), the current values in the programmer visible and control register set 107 in the MP 100 are secured, i.e., saved in the internal register set 105 during the context switch operation. In the current example, when the MP 100 has finished the parallel computation of ƒ₁(x,y), the resulting state (e.g., the programmer visible and control register values) is secured during the context switching operation, which saves the register values to the context switch internal registers 105. The context switching is performed fast, preferably in one clock cycle of the MP 100.

One or more sets of program instructions, or code 140, are stored in a memory, preferably a read-only memory (ROM). An instruction detector (ID) 150 monitors the code 140 to detect specific key machine code instructions and generate appropriate hardware interrupts, which thereby initiates context switching in the MP 100. For example, the ID 150 can detect an instruction indicating that the MP 100 has completed the calculation of ƒ₁(x,y), and issue an interrupt to the MP 100 to begin MAC computational load sharing.

A predefined coding style and code sequence is followed in writing the High Level Language (HLL) application code to allow the ID 150 to recognize the specific key instructions. For example, for the software implementation of the digital signal processing algorithm of Eq. 1, an example of predefined HLL code sequence and style at the application programming level is shown below:

m= . . . [comment: m=# of rows in filter window—determined at run-time]

n= . . . [comment: n=# of columns in filter window—determined at run time]

[comment: start of predefined code sequence]

SET DSP: FWrows=m, FWcols=n;

START DSP: f2(x,y), f2 out;

START MP: f1(x,y), fl-out;

DONE MP;

ADD MP-DSP: xy_out=f1_out+f2_out;

[comment: end of predefined code sequence]

For example, when the program flow reaches the “DONE MP” statement, completion of the task f1(x,y) is indicated. Accordingly, when the ID 150 detects the instruction for DONE MP, a context switch is initiated in the MP 100 and computational load sharing with the DSP 190 may start.

In a preferred embodiment, the MP 100 first determines the “practicability” of load sharing before context switching and beginning load sharing with the DSP 190. The practicability of load sharing is determined according to an algorithm as a function of one or more status conditions, with the most important being how much time, i.e., the number of calculations, is required to complete the current MAC computation. Other status conditions may relate to the other tasks performed by the MP 100. A DSP status counter 160 keeps track of the number of calculations still required in the current MAC computation so the MP 100 may determine the practicability of load sharing. Prior to initiating each MAC computation, the status counter 160 is initialized with the number of calculations required for the total MAC computation. The counter is decremented with each calculation performed by the DSP 190, thereby always containing the number of remaining calculations.

In the current example, the status counter 160 is initialized with the product of m×n, which represents the number of filter mask coefficients and therefore the number of calculations required for the current MAC computation. The counter is then decremented with each calculation performed by the DSP 190, thereby always containing the number of remaining calculations in the current MAC computation. The values of m and n may be determined at run-time.

For example, where m×n=200, after 180 calculations the counter will have decremented to 20. Before beginning load sharing, the MP 100 will read the value 200−180=20 from the status counter and determine, according to a practicability algorithm, whether it is practicable to share the load with the DSP 190, considering the faster processing capability of the DSP 190, the additional time/instructions required for load sharing, and the current tasks of the MP 100. The algorithm may be as simple as comparing the status counter value to a predetermined threshold based on some predetermined practicability considerations.

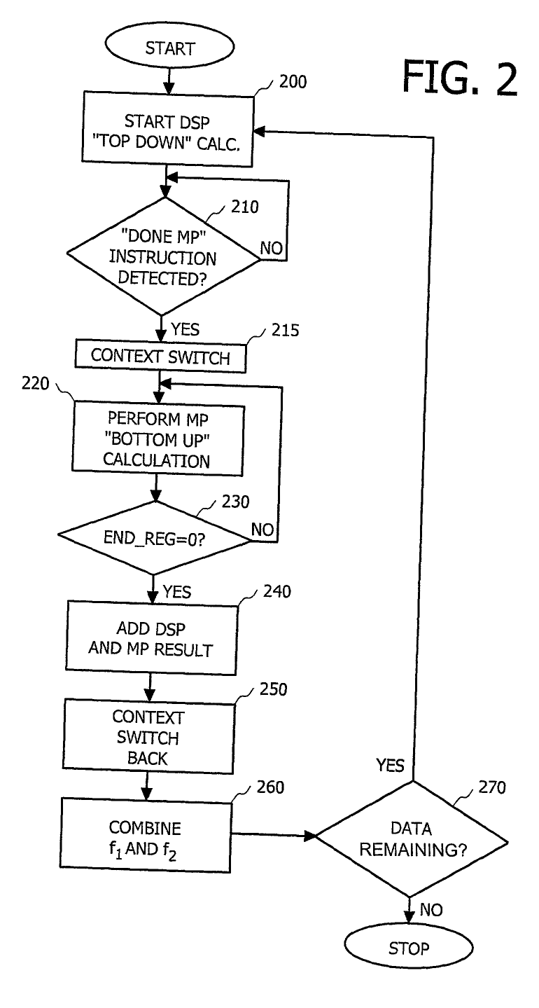

The program instructions in the code 140 include the instructions required to control and guide the MCU 100 for load sharing. The flow charts of FIGS. 2-5 illustrate exemplary methods in the context of the example provided above and according to the invention. The instructions required to carry out this method can be included in whole or in part in the code 140 and acted upon by the various other components, such as the MP 100, DSP 190, ID 150, etc.

Referring to FIG. 2, a method of load sharing is illustrated according to an embodiment of the invention. While the MAC calculations are being performed in the DSP (step 200), the MP 100 may be computing f₁. The ID 150 monitors the code 140 (step 210) being executed for a “DONE MP” instruction indicating that the MP 100 has finished computing f₁ and is available for load sharing of the DSP calculation of f₂. When the “DONE MP” instruction is detected, the ID 150 signals the MP 100, preferably via an interrupt, to context switch (step 215), thereby securing the current state and resulting f₁ of the MP 100.

Once the context switch is complete, the MP 100 begins retrieving values from the “bottom-up” of U and V memories and performing calculations on the values (step 220). After, or prior to, each calculation the value in End_Reg 104 is checked (step 230) by MP 100 to determine if the MP accessed bottom-up memory address 101 matches the DSP accessed top-down address 191. The two values are compared by address comparator 103 and a corresponding value is maintained in End_Reg 104. An accumulated value of the MP 100 and DSP 190 calculations is maintained in the respective MAC-ACC 102, 192 for each. When the End_Reg 104 indicates the MP 100 and DSP 190 addresses are the same, i.e., they have reached the meeting point, the values in each MAC-ACC 102, 192 are added together (step 240) and placed in a MAC result register 106 for later use.

The MP 100 then performs a context switch back operation (step 250) to retrieve the value of f₁. A special MAC-Result register 106 does not undergo context switching and therefore maintains the value of f₂ through the context switch. Accordingly, after the context switch back operation (step 250), the MP 100 has the values for both f₁ and f₂ available. The MP 100 then combines the values f₁ and f₂, which may involve addition, subtraction, and/or scaling. The current computation is complete when there is no other data remaining in the U and V memories 170, 180 for further processing (step 270). When additional data is remaining, however, the process returns to step 200 to begin the next calculation.

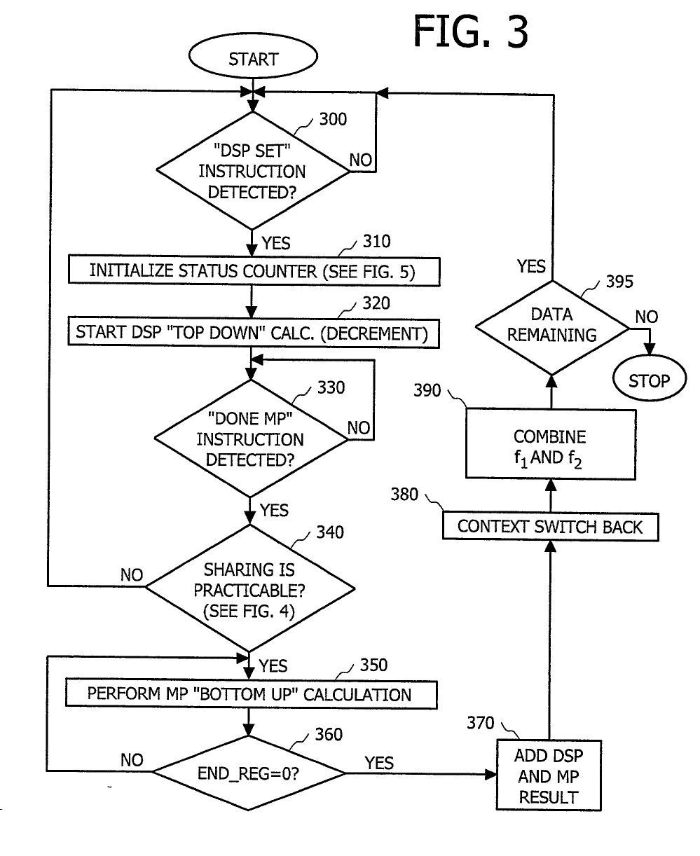

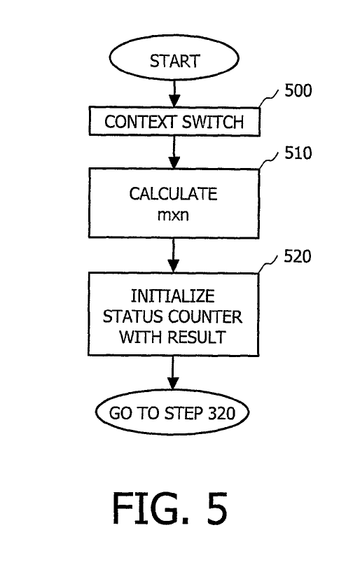

Referring to FIGS. 3-5, an alternative method of load sharing is illustrated according to another embodiment of the invention. Prior to beginning a MAC computation in the DSP, a “DSP SET” instruction is encountered. Referring to FIG. 3, the ID 150 detects (step 300) the “DSP SET” instruction and initializes the status counter 160 (step 310). The initialization procedure is further detailed in FIG. 5. A context switch is performed in the MP 100 (step 500) to secure the current state of the MP 100. The number of calculations required, e.g., m×n, is calculated (step 510). The status counter 160 is initialized with the resulting value (step 520).

Returning to FIG. 3, the DSP calculations are then started (step 320). For each calculation performed in the DSP 190, the status counter is decremented by one to always contain the number of calculations remaining in the current f₂ MAC computation. Meanwhile, the MP 100 may be computing f₁. The ID 150 monitors the code 140 (step 330) being executed for a “DONE MP” instruction indicating that the MP 100 has finished the f₁ computation, and is available for load sharing. When the “DONE MP” instruction is detected, the ID 150 signals the MP 100, preferably via an interrupt. The MP 100 then determines if load sharing is practicable (step 340) before proceeding.

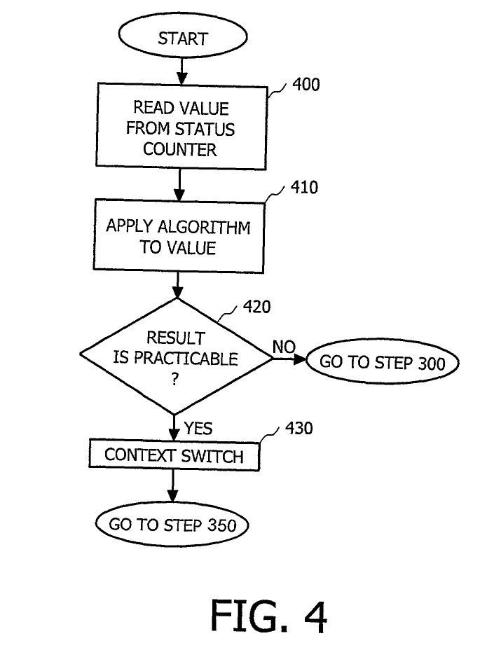

The procedure for determining practicability is further detailed in FIG. 4. The value representing the number of calculations remaining for the current MAC computation is read from the status counter 160 (step 400) and a practicability algorithm is applied to the value (step 410) to obtain a result. Practicability is determined (step 420) based on the result. For example, the result may be compared to a threshold value to determine practicability. If sharing is practicable, the MP 100 is context switched (step 430), thereby securing the current state of the MP 100, otherwise the MP 100 waits for the next “DSP SET” instruction (step 300).

Returning again to FIG. 3, once the context switch is complete, the MP 100 begins retrieving values from the “bottom-up” of U and V 170, 180 memories and performing calculations on the values (step 350). After, or prior to, each calculation the value in End_Reg 104 is checked (step 360) to determine if the MP bottom-up memory address 101 matches the DSP top-down address 191. When the End_Reg 104 indicates the MP 100 and DSP 190 addresses are the same, i.e., they have reached the meeting point, the values in each MAC-ACC 101, 191 are added together (step 240) and placed in the MAC result register 106 for later use. The MP 100 may then context switch back (step 380) to obtain a final value (step 390) and continue processing as needed (step 395), as described above.

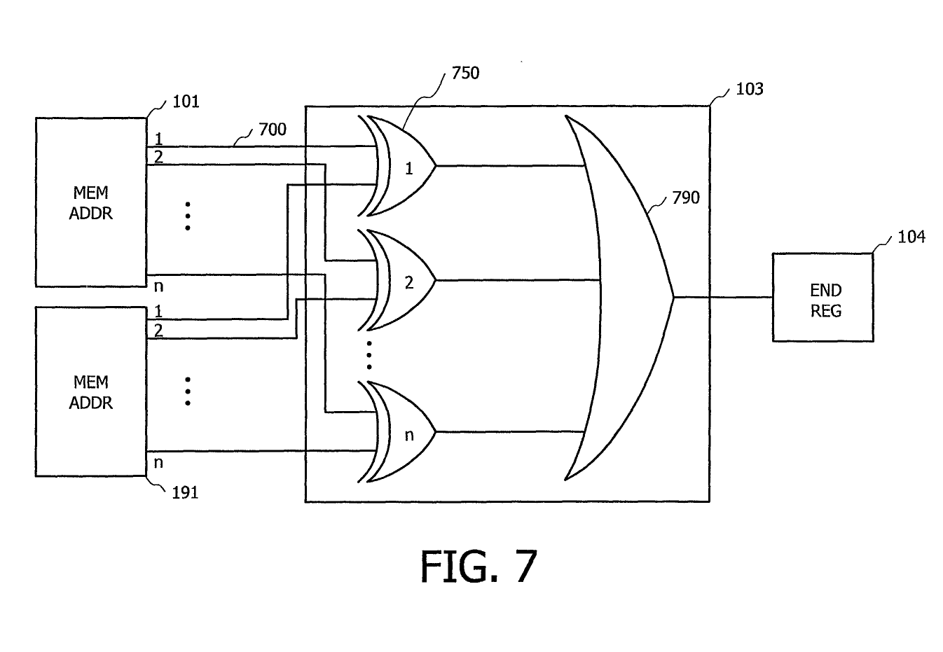

FIG. 7 illustrates a logic diagram for a simple implementation of address comparator circuit 103. It will be understood by one of ordinary skill in this art that many other comparator configurations may be employed in hardware or software to perform the functions need by the present invention. A number n of address lines 700 each provide one bit of a current n-bit data address in the memory address registers 101, 191. One such address line 700 from each of the memory address registers 101, 191 is provided to a corresponding one of n exclusive-or (XOR) gates 750. Accordingly, there is one XOR gate 750 for each corresponding pair of address lines 700 having the same bit weight, i.e., same bit location in the n-bit memory address, from the memory address registers 101, 191. That is, each XOR gate 750 performs a comparison of one bit of the n-bit address in the memory address register 101 with the corresponding bit in the n-bit memory address register 191. A zero is output by the respective XOR gate 750 only when the corresponding bits are the same, i.e., 1, 1 or 0, 0.

The output of all n XOR gates 750 are connected to an OR gate 790, which is connected to the End_Reg 104. If the output of all the XOR gates 750 is zero, then the output of the OR gate 790 is zero, which sets the value in the End_Reg 104 to zero. Therefore, only when all bits of the n-bit addresses in the memory address registers 101, 191 match, i.e., the addresses are the same, is End_Reg 104 set to zero, indicating the MP 100 and DSP 190 have reached the meeting point as discussed above.

According to the invention a main processor autonomously shares the computation load of its companion DSP(s). The load sharing occurs at run-time or on the fly and does not require major software based scheduling. While load sharing between a main processor and one DSP is described above by way of example, one of ordinary skill in the art will recognize that the described load sharing technique may be performed between any processor that acts as a master processor and one or more other slave processors. In addition, a particular calculation is described above by way of example, i.e., pixel filtering. It will be understood that the load sharing technique may be used for any MAC type computation. Therefore, although described with reference to a specific multi-processor system performing a specific task, the embodiments described above should be considered in all respects to be illustrative and not restrictive.

It will be appreciated that the steps of the methods illustrated above may be readily implemented either by software that is executed by a suitable processor or by hardware, such as an application-specific integrated circuit (ASIC).

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method of computational load sharing between a general-purpose processor and one or more specific-purpose processor(s) in a multiprocessor system, comprising the steps of:
retrieving and processing one or more values, by the one or more specific-purpose processor(s), from a set of values in a common memory according to a first memory accessing sequence, the one or more values being processed to obtain a first cumulative result;
retrieving and processing one or more other values, by the general-purpose processor, from the set of values in said common memory according to a second memory accessing sequence, the one or more other values being processed to obtain a second cumulative result; and
combining the first and second cumulative results to obtain a final result of a current cumulative computation.

2. The method of claim 1, wherein the step of combining includes determining, according to a comparison of corresponding memory addresses, whether the general-purpose processor and the one or more specific-purpose processor(s) are attempting to retrieve a same value from the set of values and, if so, combining the first and second cumulative results.

3. The method of claim 1, wherein the first memory accessing sequence is a bottom-up sequence and the second memory accessing sequence is a top-down sequence.

4. The method of claim 1, comprising the preliminary step of:
determining if computational load sharing between the general-purpose processor and the one or more specific-purpose processor(s) is practicable, and initiating computational load sharing only when it is practicable.

5. The method of claim 4, wherein to determine the practicability of computational load sharing, the general-purpose processor determines how many calculations are remaining in the current cumulative computation and compares the remaining number of calculations to a threshold.

6. The method of claim 1, comprising the preliminary step of detecting when the general-purpose processor is available for load sharing.

7. The method of claim 1, comprising the preliminary step of performing a context switch at the general-purpose processor.

8. A system for computational load sharing comprising:
one or more specific-purpose processor(s) adapted to retrieve and process one or more values from a set of values in a common memory according to a first memory accessing sequence, the one or more values being processed to obtain a first cumulative result;
a general-purpose processor adapted to retrieve and process one or more other values from the set of values in said common memory according to a second memory accessing sequence, the one or more other values being processed to obtain a second cumulative result; and
logic that combines the first and second cumulative results to obtain a final result of a current cumulative-computation.

9. The system of claim 8, further comprising logic that determines when all values in the set of values have been retrieved and prompts the combination of the first and second cumulative results.

10. The system of claim 8, wherein the first memory accessing sequence is a bottom-up sequence and the second memory accessing sequence is a top-down sequence.

11. The system of claim 8, additionally comprising logic that determines if computational load sharing between the general-purpose processor and the one or more specific-purpose processor(s) is practicable and only begins computational load sharing when it is practicable.

12. The system of claim 11, wherein to determine the practicability of computational load sharing, the system includes logic that determines how many calculations are remaining in the current cumulative computation and compares the remaining number of calculations to a threshold.

13. The system of claim 8, further comprising an instruction detection means that detects when the general-purpose processor is available for load sharing and interrupts the general-purpose processor to initiate a context switch and begin the computational load sharing at the general-purpose processor.

14. The system of claim 8, wherein the current cumulative computation is a MAC computation.

15. The system of claim 8, further comprising an address comparator that compares a memory address accessed by the general-purpose processor to a memory address accessed by the one or more specific-purpose processor(s) to provide an indication when the current cumulative computation is complete.

16. The system of claim 15, wherein the address comparator provides an indication that the current cumulative computation is complete when the general-purpose processor is attempting to access the same memory location as the one or more specific-purpose processors.

17. A general-purpose processor adapted for computational load sharing, comprising:
logic that retrieves and processes a subset of values from a common set of values according to an accessing sequence while a different subset of the common set of values is being retrieved by one or more specific-purpose processors according to a different accessing sequence, the subset of values being processed to obtain a cumulative result; and
logic that combines the cumulative result with other cumulative results processed by the one or more specific-purpose processors to obtain a final result of a current cumulative computation.

18. The general-purpose processor of claim 17, additionally comprising logic that determines if computational load sharing between the general-purpose processor and the one or more specific-purpose processor(s) is practicable and only begins computational load sharing when it is practicable.

19. The general-purpose processor of claim 18, wherein to determine the practicability of computational load sharing, the general-purpose processor includes logic that determines how many calculations are remaining in the current cumulative computation and compares the remaining number of calculations to a threshold.

20. The general-purpose processor of claim 17, wherein the set of values are stored and accessed in a common memory and the general-purpose processor further comprises address comparator logic that compares a memory address in the common memory accessed by the general-purpose processor to a memory address accessed by the one or more specific-purpose processor(s) to provide an indication when the current cumulative computation is complete.

21. The general-purpose processor of claim 20, wherein the address comparator logic provides an indication that the current cumulative computation is complete when the general-purpose processor is attempting to access the same memory location as the one or more specific-purpose processors.
